(19) United States
(12) Patent Application Publication
(10) Pub. No.: US 2017/0181069 A1
(43) Pub. Date: Jun. 22, 2017

(54) METHODS AND APPARATUS FOR SELECTING A CELL HAVING A PARTICULAR TYPE OF SERVICE

(71) Applicant: QUALCOMM Incorporated, San Diego, CA (US)

(72) Inventors: Mungal Singh Dhanda, Slough (GB); Ankur Srivastava, Hyderabad (IN); Deepanksh Goyal, Hyderabad (IN); Kishore Kumar Yannakula, Hyderabad (IN); Gaurav Kumar, Hyderabad (IN)

(21) Appl. No.: 14/973,538

(22) Filed: Dec. 17, 2015

(51) Int. Cl. H04W 48/18; H04W 48/16; H04W 76/02

(52) U.S. Cl. CPC H04W 48/18; H04W 76/02; H04W 48/16

(57) ABSTRACT

Disclosed are methods and apparatus for selecting a cell having a particular type of service, such as packet switched (PS) service. The methods and apparatus effect determination within a mobile device of signal strength for at least one cell and whether the at least one cell meets signal strength and path loss criteria based on the determined signal strength. A determination is then made whether the at least one cell supports PS for a PS only device, and a selection to receive service from or camp on the cell is then made when the at least one cell has been determined to support PS. By effecting such selection in PS only devices such as Class C devices, the mobile devices will have PS service for which they are designed and avoids cells having only circuit switched service that would provide no service for the PS only device.

### TECHNICAL FIELD

The following disclosure relates generally to wireless communication, and more specifically to methods and apparatus for selecting or camping on a cell having a particular type of service (e.g., Packet Switched (PS) service) for particular types of User Equipment (UE) or Mobile Stations (MS).

### BACKGROUND

In 3GPP Release 10, the GSM EDGE Radio Access Network (GERAN) specifications removed the need for terminals only supporting General packet radio service (GPRS, which is a Packet Switched (PS) domain) to support any Circuit Switched (CS) domain procedures. The cell selection and reselection algorithm, however, was not changed to take into account device capability (i.e., devices that support PS only or PS+CS). Accordingly, if a device is configured for PS service only, such as what is known as a Class C type device, the device could conceivably camp on a cell that does not provide GPRS (i.e., PS) service and the User Equipment (UE) will therefore be deprived of PS service even though the device supports it. It is noted here that Class C devices are of a type that are connected to either GPRS service or GSM service (voice, SMS), whereas a Class A device is one that can be connected to GPRS service and GSM service (voice, SMS), using both at the same time, and a Class B device is one that can be connected to GPRS service and GSM service (voice, SMS), but uses only one of the services at a time.

There is no specification guidance directing that a UE should always select a CS+PS cell. Rather, the specification only indicates that a UE should select a best possible cell in terms of power level for all classes of device. Hence, a user may be deprived of PS service (Camped on Cell A) even though there is a good Cell B cell which supports CS+PS. Further, cell reselection will not be triggered if the user is stationary as Cell A will remain to continue to be better in terms of power. Thus, in the case where a Class C device camps on a cell that does not provide GPRS, the device would indicate to a user that the device has good coverage, even though there would be no PS service. For example, in some locations a situation could arise where there is a Cell A, which supports CS, and a Cell B, which supports CS and PS, but due to a better level of power of Cell A, the UE will camp on Cell A even though it doesn't support GPRS (PS). In this case, a Class C UE would not have any service, not even emergency service.

Accordingly, there is a need for methods and apparatus to ensure that a device camps on the best possible cell in a wireless system, but that the criteria for camping of a cell should not be based solely on the power level, but also on the service which the cell can provide and the service which device supports as well.

### SUMMARY

According to an aspect of the present disclosure, a method for wireless communication is disclosed. The method includes determining within a mobile device at least a signal strength for at least one cell and whether the at least one cell meets at least one of signal strength and path loss criteria based on the determined signal strength. Further, the method includes determining whether the at least one cell supports packet switched service (PS), and selecting to receive service from the cell when the at least one cell supports packet switched service.

According to another aspect a mobile device is disclosed that includes a communications interface configured to communicate in at least one radio access network, a storage medium, and a processing circuit coupled to the communications interface and the storage medium. The processing circuit is configured to determine within a mobile device at least a signal strength for at least one cell and whether the at least one cell meets at least one of signal strength and path loss criteria based on the determined signal strength. Furthermore, the processing circuit is configured to determine whether the at least one cell supports PS. The processing circuit is also configured to select to receive service from the cell when the at least one cell supports packet switched service.

In yet another aspect, a disclosed apparatus for wireless communication includes means for determining within a mobile device at least a signal strength for at least one cell and whether the at least one cell meets at least one of signal strength and path loss criteria based on the determined signal strength. The apparatus also includes means for determining whether the at least one cell supports packet switched service (PS). Additionally, the apparatus includes means for selecting to receive service from the cell when the at least one cell supports packet switched service.

According to still another aspect, a computer program product for selecting a cell in a wireless communication system is disclosed. The computer program product includes a computer-readable storage medium featuring code for causing a computer to determine within a mobile device at least a signal strength for at least one cell and whether the at least one cell meets at least one of signal strength and path loss criteria based on the determined signal strength. The medium also includes code for causing a computer to determine whether the at least one cell supports packet switched service (PS), and code for causing a computer to select to receive service from the cell when the at least one cell supports packet switched service.

### DRAWINGS

FIG. 1 illustrates an exemplary wireless network environment in which the presently disclosed methods and apparatus may be implemented.

FIG. 2 illustrates a flow diagram of an exemplary method for selecting a cell to camp on with a UE.

FIG. 3 illustrates a flow diagram of an exemplary method for cell reselection in a UE when a UE is presently camping on a particular cell.

FIG. 4 illustrates a flow diagram of another exemplary method for selecting or camping on a particular cell.

FIG. 5 illustrates a block diagram of a UE or mobile station that is configured to select a cell having a particular type of service.

FIG. 6 illustrates a block diagram of another apparatus configured to select a cell having a particular type of service.

### DETAILED DESCRIPTION

The description set forth below in connection with the drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques, and components are shown in block diagram form to avoid obscuring the described concepts and features. Additionally, the word “exemplary” is used herein to mean “serving as an example, instance, or illustration.” Any example described herein as “exemplary” is not necessarily to be construed as preferred or advantageous over other disclosed examples.

The present disclosure provides a description of methods and apparatus for camping on or reselecting a suitable cell having a particular type of service (e.g., a Packet Switched (PS)) service for particular types of User Equipment (UE) or Mobile Stations (MS) that are PS only devices (e.g., Class C devices). In one aspect, instead of simply selecting a cell based on when cell selection or reselection is triggered, the present disclosure provides for a modification of cell selection/reselection process for PS only devices including determining in a UE from system messages from a cell whether the cell supports PS (i.e., GPRS). An additional determination in a UE can be made to determine whether a cell supports PS service through the use of system information (SI) messages received from the cell. In particular, an initial power scan could be checked where the neighboring cells are listed in decreasing order of power level. While checking for a suitable cell a System Information message (e.g., an SI3 message within GSM System Information message transmitted from a network node over a Broadcast Control Channel (BCCH) or a Slow Associated Control Channel (SACCH)) could be checked to determine whether the cell supports PS (e.g., GPRS). If the cell supports PS, the UE is then allowed to proceed to camp on that cell. If not, however, then the UE will ignore the cell and go for a next best cell. If no other better cell is found that supports PS service, then the UE device can indicate no service to a user and enter a power save mode and/or return to checking for other cells. It is also noted that a device that does not support CS mode is not able to support emergency calls and, hence, there would be no need for the device to camp on any cell for emergency calls only. In this way the UE will have the PS service for which it is designed.

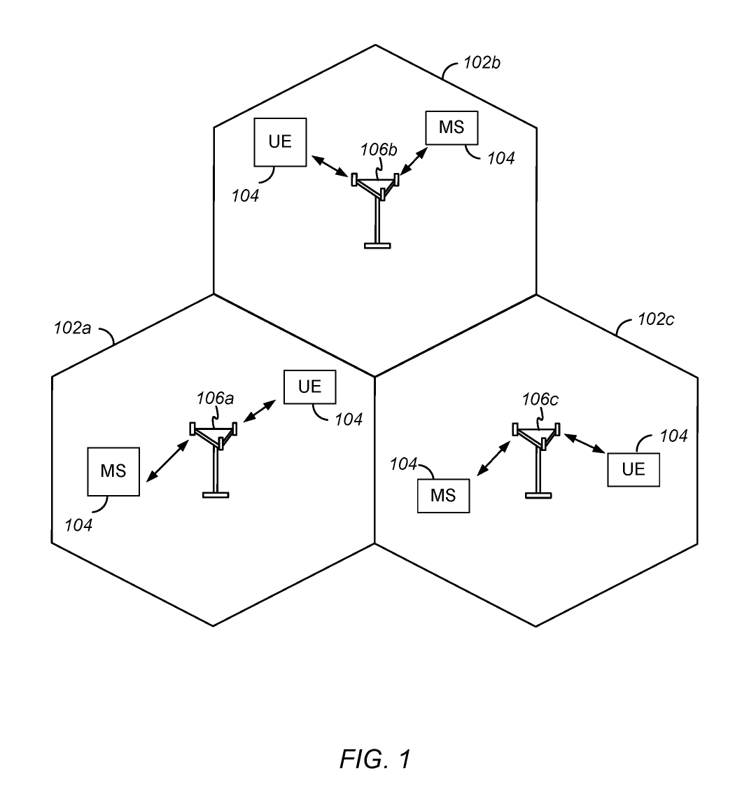

FIG. 1 illustrates an example of a wireless network environment 100 in which the presently disclosed methods and apparatus may be implemented. The environment 100 is a multi-cell (e.g., 102a, 102b, 102c) as well as multi-RAN environment where multiple RAN technologies may be present and one or more User Equipment (UE) or Mobile Stations (MS) 104 have mobility across the various RANs. In one example, the RAN technologies may be GSM (or GERAN) and GPRS, but the concepts disclosed herein may be applied to other RAN technologies as well.

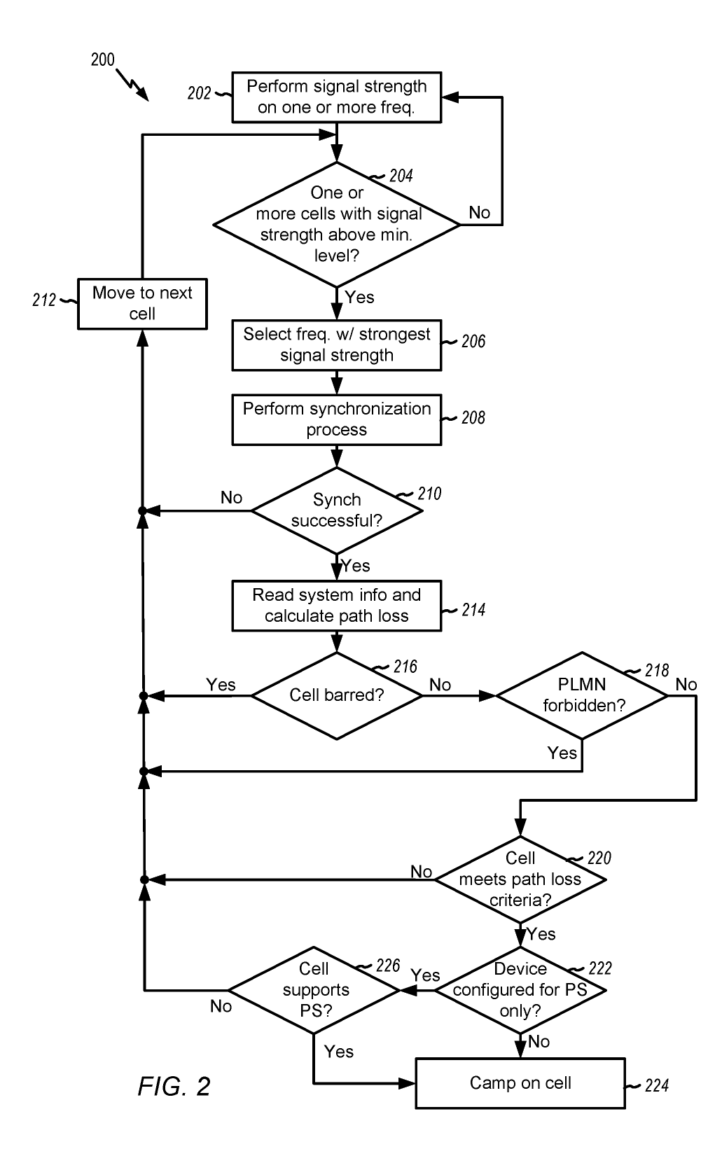

Base stations 106 may also be referred to as, and may include some or all of the functionality of various transceiver devices across various technologies including devices termed NodeB, evolved NodeB (eNodeB or eNB), access point, base transceiver station (BTS), broadcast transmitter, etc. Each base station 106 provides communication coverage for a particular geographic area. A base station 106 may provide communication coverage for one or more wireless communication devices 104. The term “cell” can refer to a base station 106 and/or its coverage area depending on the context in which the term is used. The base stations 106 can wirelessly communicate with the access terminals 104 via a base station antenna. The base stations 106 may each be implemented generally as a device adapted to facilitate wireless connectivity (for one or more access terminals 104) to the wireless communications system 100. The base stations 106 are configured to communicate with the access terminals 104 under the control of base station control (see FIG. 2) via multiple carriers. Each base station 106 can provide radio access communication coverage for a respective geographic area. The coverage area 102 for each base station 106 here is identified as cells 102a, 102b, and 102c, for example. The coverage area 102 for a base station 106 may be divided into sectors (not shown), which make up only a portion of the coverage area. The system 100 may include base stations 106 of different types (e.g., macro, micro, femto, and/or pico base stations).

One or more mobile stations 104 may be extant within the coverage areas 102. Each MS 104 may communicate with one or more base stations 106. An MS 104 may generally include one or more devices that communicate with one or more other devices through wireless signals. Although the GSM designation MS is used in this description, it will be appreciated that other known nomenclatures describing mobile wireless devices such as access terminal, user equipment (UE), subscriber station, mobile unit, subscriber unit, wireless unit, remote unit, mobile device, wireless device, wireless communications device, remote device, mobile subscriber station, mobile terminal, wireless terminal, remote terminal, handset, terminal, mobile client, client, or some other suitable terminology may be applicable.

Although the terminology MS and UE is used predominantly in this disclosure, other terms suitable for describing MS 104 could include a mobile phone, smart phone, wireless modem, personal media player, laptop computer, tablet computer, network enabled television, appliance, e-reader, digital video recorder (DVR), a machine-to-machine (M2M) device, and/or other communication/computing device which communicates, at least partially, via a radio access network.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) GERAN and Long Term Evolution (LTE) systems and spatial division multiple access (SDMA) systems.

FIG. 2 illustrates a flow diagram of an exemplary method for selecting a cell to camp on with a UE. The method 200 represents a modification of a known legacy cell selection process, and is applicable for use with PS only devices such as a Class C device. In an aspect, method 200 is implemented by a UE in conjunction with signals received by the UE from a network.

As illustrated in block 202 of FIG. 2, an initial power scan is initiated to determine the signal strength of one or more frequencies. The outcome of this scan may include the generation of a list of cells in decreasing order of power level. A determination is made based on this information whether one or more neighboring cells have signal strength above a predetermined minimum power level as indicated in decision block 204. The predetermined value may be based on predefined standards or an experientially determined minimum signal strength used to achieve a desired level of service. If none of the scanned frequencies is above the requisite minimum level, flow returns to block 204 to check if the next selected neighboring cell has signal strength above the minimum level.

If one or more of the frequencies is above the minimum as determined at block 204, the frequency with the strongest signal strength is selected as shown at block 206. Next, a synchronization process is performed between the UE and the base station as shown in block 208. If the synchronization process is unsuccessful as determined at decision block 210, then the procedure moves to a next cell in the list of cells as indicated at block 212, and method 200 returns to repeat the comparison in block 204. On the other hand, if the synchronization is successful, then the system information is read and the path loss for that cell is determined or calculated as shown in block 214.

Next, based on the system information and the path loss, a determination is made whether the cell is barred for use by the UE as illustrated by decision block 216. If so, then the flow returns to block 212 where a next cell is selected from the UEs library of neighboring cells. If the cell is not barred, however, then flow proceeds to decision block 218 for determination whether a particular public land mobile network (PLMN) associate with the particular cell is forbidden. If so, flow proceeds to block 212 where the next cell is selected from the UEs library of neighboring cells.

On the other hand, if the PLMN is allowed as determined at block 218, then the flow proceeds to decision block 220 to determine if the cell meets a predetermined path loss criteria based on the already calculated path loss. If the path loss criteria are not met, flow proceeds back to block 212 for selection of a next cell. In the alternative at block 220, flow proceeds to block 222 to determine whether the particular UE device is configured for PS (e.g., GPRS) only. If not, such as in the case of a Class A or Class B device, then the UE proceeds to block 224 where the UE then camps on the cell. On the other hand, if the device is only configured for PS, then flow proceeds to decision block 226 for a determination whether the cell supports PS service. If so, then the device proceeds to camp on the cell as illustrated by block 224. In the alternative at block 226, if the cell does not support PS service, flow then flow returns to block 212 where a next cell in the UEs neighboring cell list is selected. In an aspect, it is noted that determining whether the cell supports PS (e.g., GPRS) may be accomplished by checking a GSM System Information message (e.g., an SI3 message) received from a network node, such as a base station (e.g., base station 106 in FIG. 1). Further, in another aspect the system information message may be read during the process of block 214.

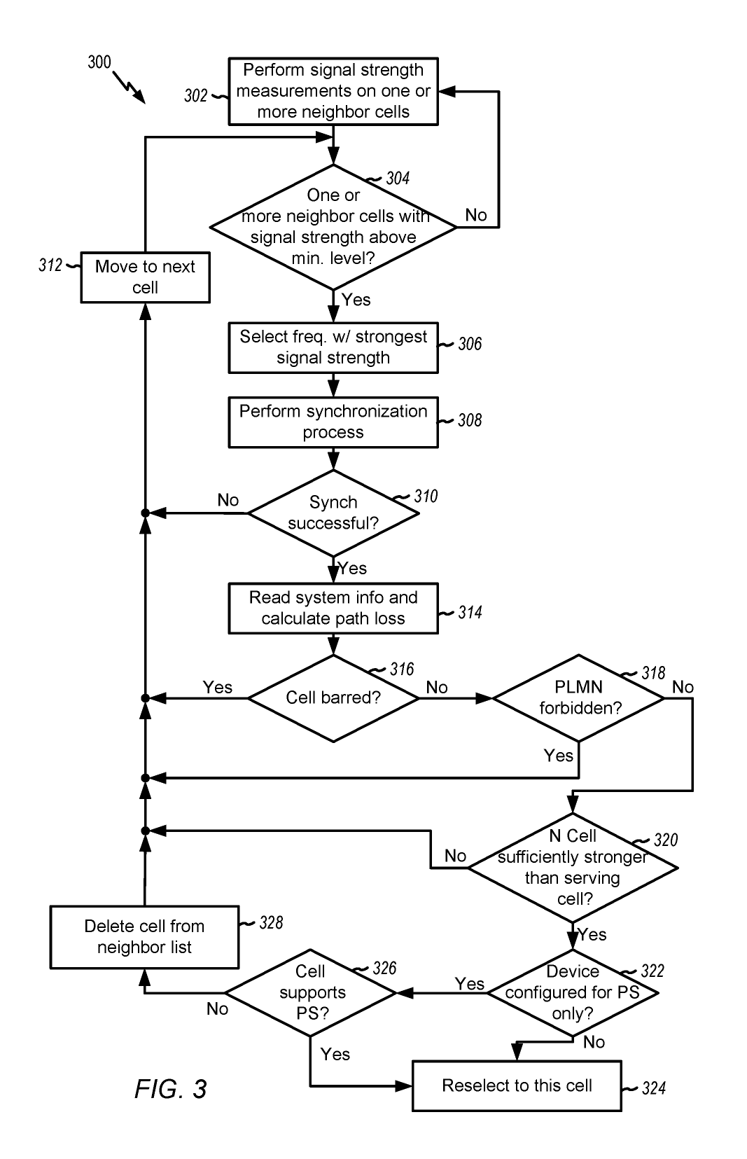

FIG. 3 illustrates an exemplary method 300 for cell reselection in a UE when a UE is presently camping on a particular cell. Similar to method 200, method 300 represents a modification of a known legacy cell reselection process, and is applicable for use with PS only devices such as a Class C device. In an aspect, method 300 is implemented by a UE in conjunction with signals received by the UE from a network.

As illustrated in block 302 of FIG. 3, signal strength measurements are performed on one more neighboring cells to determine their respective signal strengths. The outcome of these measurements may include the generation of an updated or revised list of neighboring cells, and may also be arrange in decreasing order of power level. A determination is made based on this information whether one or more neighboring cells have signal strength above a predetermined minimum power level as indicated in decision block 304. The predetermined value may be based on predefined standards or am experientially determined minimum signal strength used to achieve a desired level of service. If none of the signal strengths of the neighboring cells is above the requisite minimum level, flow returns to block 304 to determine if the next neighboring cell has signal strength above the predetermined minimum level.

If one or more of the neighboring cell signal strengths is above the minimum as determined at block 304, the cell with the strongest signal strength is first selected as shown at block 306. Next, a synchronization process is performed between the UE and the base station as shown in block 308. If the synchronization process is unsuccessful as determined at a decision block 310, then the method 300 moves to a next cell from the list of cells as indicated at block 312, and flow returns to repeat the comparison in block 304. On the other hand, if the synchronization is successful, then the system information is read and the path loss for that cell is determined or calculated as shown in block 314.

Next, based on the system information and the path loss, a determination is made whether the cell is barred for use by the UE as illustrated by decision block 316. If so, then the flow returns to block 312 where a next cell is selected from the UEs library of neighboring cells. If the cell is not barred, however, then flow proceeds to decision block 318 for determination whether a particular public land mobile network (PLMN) associate with the particular cell is forbidden. If so, flow proceeds to block 312 where the next cell is selected from the UEs library of neighboring cells.

On the other hand, if the PLMN is allowed as determined at block 318, then the flow proceeds to decision block 320 to determine if the neighboring cell (N cell) is sufficiently stronger than the current serving cell. The particular quantitative measure of what constitutes “sufficiently stronger” in block 320 may be determined experientially or based on a predetermined threshold set by the standards or otherwise. If the cell strength is not sufficiently stronger than the currently serving cell, flow proceeds back to block 312 for selection of a next cell. In the alternative at block 320, if the neighboring cell under consideration possesses a signal strength sufficiently stronger than the current serving cell, flow proceeds to block 322 to determine whether the particular UE device is configured for PS (e.g., GPRS) only. If not, such as in the case of a Class A or Class B device, then the UE proceeds to block 324 where the UE then reselects to the cell.

On the other hand at decision block 322, if the device is only configured for PS only then flow proceeds to decision block 326 for a determination whether the cell supports PS service. If the cell supports PS service, then the device proceeds to reselect to the cell as illustrated by block 324. In an aspect, it is noted that determining whether the cell supports PS (e.g., GPRS) may be accomplished by checking a System Information message (e.g., an SI3 message) received from a network node, such as a base station (e.g., base station 106 in FIG. 1). Further, in another aspect the system information message may be read during the process of block 314.

In the alternative at block 326, if the cell does not support PS service, flow then proceeds to block 328 where the cell is deleted from the UEs list of neighboring cells. From block 328, flow then proceeds to block 312. It will be appreciated that the determination in block 326 and the subsequent delisting in block 328 allows a Class C UE, for example, to eliminate a particular cell not supporting PS from any further consideration for reselection purposes. As explained before, there is no benefit for such types of UEs to camp on a cells that does not support PS (e.g., GPRS), as there would not even be emergency service available to the device.

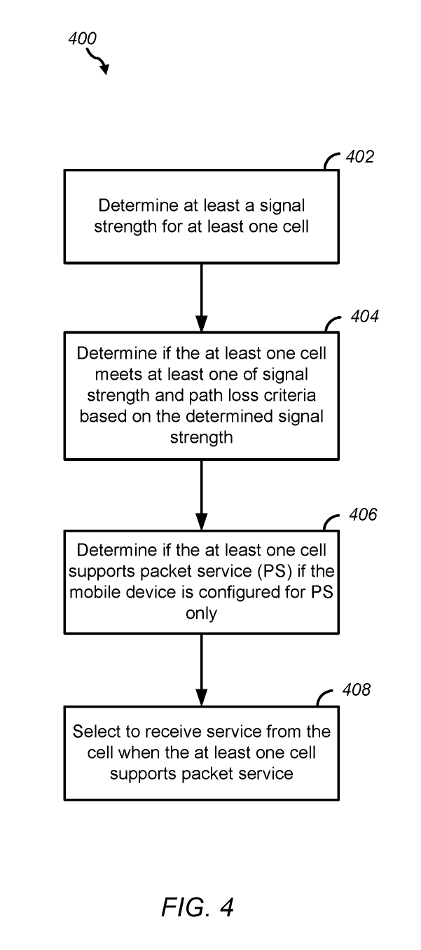

FIG. 4 illustrates another exemplary method 400 for selecting or camping on a particular cell. As illustrated, method 400 includes determining within a UE or mobile device at least a signal strength for at least one cell as shown in block 402. This process may include a scanning process whereby the UE scans for cells in proximity to the UE, and determining signal strength of available frequencies (in the case of initial cell selection) or neighboring cells (in the case of reselection). In an aspect, the process 402 engenders the creation (or update) of a neighbor list (or available cell list) in the UE.

After the process of block 402, the flow proceeds to block 404 for determination of whether the at least one cell meets at least one of signal strength and path loss criteria based on the determined signal strength. In an aspect, this process involves selecting a strongest cell or frequency, such as was illustrated in processes 206 or 306.

Method 400 further includes determining whether the at least one cell supports packet switched service (PS) if the mobile device is configured for PS only as illustrated by block 406. In an aspect, the process in block 406 may include determination of whether the device is configured for PS only (e.g., configured as a GPRS Class C device) before determining whether the cell supports PS as shown in blocks 222 or 322.

If the at least one cell supports packet switched service, then the UE selects to receive service from the cell (i.e., camp on the cell) as shown in block 408. In the case of initial selection, the UE is deciding upon which cell to camp on, whereas in the case of reselection, the UE is reselecting a better cell based on, in part, whether the cell is stronger than a current serving cell (See e.g., process 320 in FIG. 3). In another aspect, the method 400 may further include deleting those cells not supporting PS from the UEs neighbor list as shown by process 328, for example.

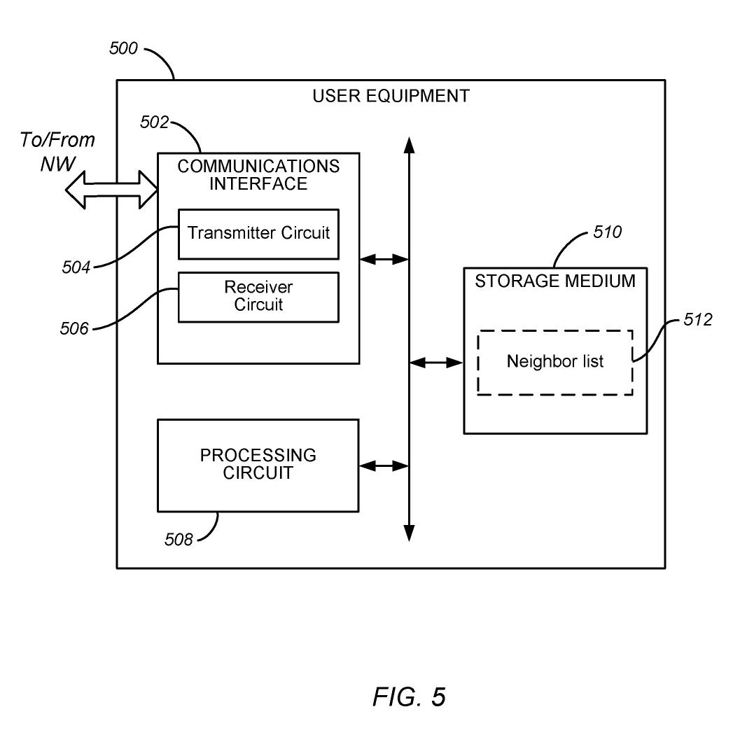

FIG. 5 illustrates a UE or mobile station 500 that is configured to select a cell having a particular type of service. In an aspect, the UE 500 may be a Class C device configured in accordance with GSM EDGE Radio Access Network (GERAN) specifications and operable in at least a GERAN environment. The mobile station 500 is illustrated showing select components of the station 500 or a modem therein that includes a communication interface 502 for wireless communication with one or more RANs. The interface 502 includes both receive 504 and transmit 506 circuits. For simplicity the interface 502 is shown singular, but one skilled in the art will realize that interface 502 may consist of multiple radio circuits each configured to communicate with respective RAN technologies.

Station 500 also includes processing circuitry 508 communicatively coupled with the communications interface 502 and storage medium 510. The circuitry 508 may be implemented as one or more processors, one or more controllers, and/or other structure configured to execute executable programming. Storage medium 510 may be engendered as one or more computer-readable, machine-readable, and/or processor-readable devices for storing programming, such as processor executable code or instructions (e.g., software, firmware), electronic data, databases, or other digital information.

The processing circuitry 508 is arranged to obtain, process and/or send data, control data access and storage, issue commands, and control other desired operations. Circuitry 508 may be implemented as one or more processors, one or more controllers, and/or other structure configured to execute executable programming, including, but not limited to, a general purpose processor, a Digital Signal Processor (DSP), an Application Specific Integrated Circuit (ASIC), a Field Programmable Gate Array (FPGA), or any other programmable logic component, discrete gate or transistor logic, discrete hardware components, or any combination thereof designed to perform the functions described herein. A general purpose processor may include a microprocessor, as well as any conventional processor, controller, microcontroller, or state machine. Circuitry 508 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuitry 508 are for illustration and other suitable configurations within the scope of the present disclosure are also contemplated.

The processing circuitry 508 is adapted for processing, including the execution of programming, which may be stored on the storage medium 510. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In operation, the communications interface 502 is configured to facilitate wireless communications of the station 500. For example, the communications interface 502 may include circuitry and/or programming adapted to facilitate the communication of information bi-directionally with respect to one or more network nodes. The communications interface 502 may be coupled to one or more antennas (not shown), and includes wireless transceiver circuitry, including at least one receiver circuitry 506 (e.g., one or more receiver chains) and/or at least one transmitter circuitry 504 (e.g., one or more transmitter chains). By way of example and not limitation, the at least one receiver circuitry 506 may include circuitry, devices and/or programming associated with a data path (e.g., antenna, amplifiers, filters, mixers) and with a frequency path (e.g., a PLL component).

The storage medium 510 may represent one or more computer-readable, machine-readable, and/or processor-readable devices for storing programming, such as processor executable code or instructions (e.g., software, firmware), electronic data, databases, or other digital information. The storage medium 510 may also be used for storing data that is manipulated by the processing circuitry 508 when executing programming. Moreover, storage medium 510 may be any available medium that can be accessed by a general purpose or special purpose processor, including portable or fixed storage devices, optical storage devices, and various other mediums capable of storing, containing and/or carrying programming. By way of example and not limitation, storage medium 510 may include a computer-readable, machine-readable, and/or processor-readable storage medium such as a magnetic storage device (e.g., hard disk, floppy disk, magnetic strip), an optical storage medium (e.g., CD, DVD), a smart card, a flash memory device (e.g., card, stick, key drive), RAM, ROM, PROM, EPROM, electrically erasable EEPROM, a register, a removable disk, and/or other mediums for storing programming, as well as any combination thereof.

The storage medium 510 may be communicatively coupled to the processing circuit 508 such that the processing circuitry 508 can read information from, and write information to, the storage medium 510. That is, the storage medium 510 can be coupled to the processing circuitry 508 so that the storage medium 510 is at least accessible by the processing circuitry 508, including examples where the storage medium 510 is integral to the processing circuitry 508 and/or examples where the storage medium 510 is separate from the processing circuitry 508 (e.g., resident in the access terminal 500, external to the access terminal 500, and/or distributed across multiple entities).

Programming stored by the storage medium 510, when executed by the processing circuitry 508, causes the processing circuitry 508 to perform one or more of the various functions and/or process steps described herein. Additionally, the storage medium may be used to store data such as a neighbor list or database as illustrated by block 512. As disclosed, the UE or mobile station's neighbor list 512 may be established and/or maintained in the UE, and would be accomplished in conjunction with the processing circuitry and the communications interface 502. Furthermore, the list 512 may be maintained in such a way that those cells not supporting PS service are deleted from the list Thus, according to one or more aspects of the present disclosure, the processing circuitry 508 is adapted to perform (in conjunction with the storage medium 510) any or all of the processes, functions, steps and/or routines for any or all of the access terminals 104 described herein. As used herein, the term “adapted” in relation to the processing circuitry 508 may refer to the processing circuitry 508 being one or more of configured, employed, implemented, and/or programmed (in conjunction with the storage medium 510) to perform a particular process, function, step and/or routine according to various features described herein.

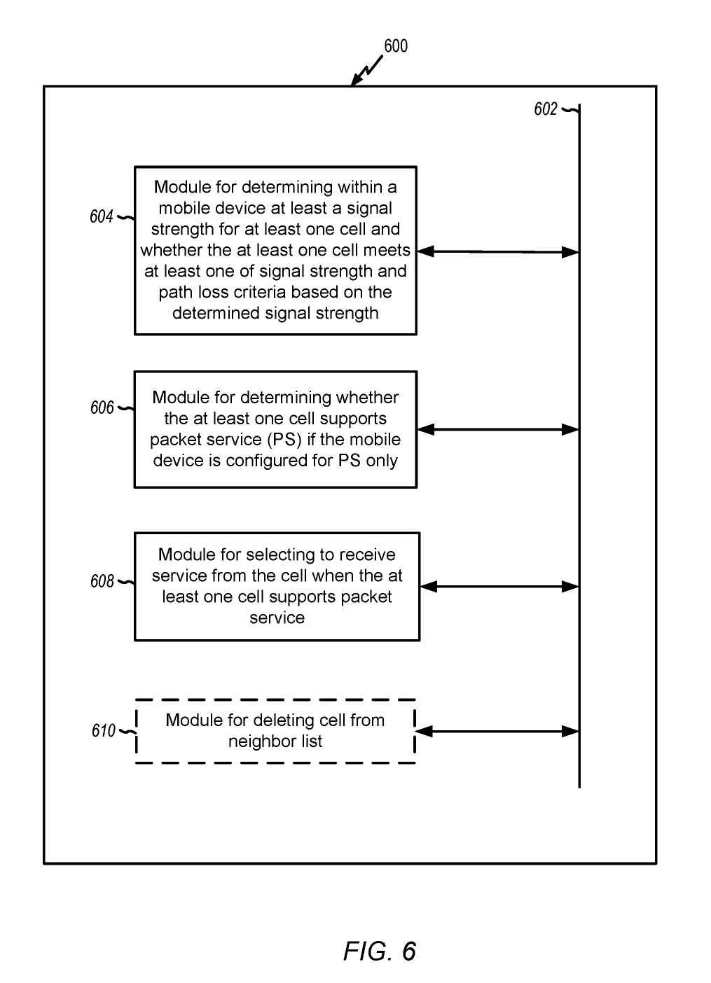

FIG. 6 illustrates an exemplary apparatus 600 configured to select a cell having a particular type of service. Apparatus 600 may be utilized or operable within a UE or mobile station, such as UE 104 in FIG. 1 or UE 500 in FIG. 5, or may be constitute a UE itself. The apparatus 600 includes various modules, circuitry, logic, or means that may be used to implement the processes or operations of FIGS. 2-4, for example. Each of the modules, circuitry, logic, or means in apparatus 600 are communicatively coupled, as illustrated by a communication bus 602 shown merely to indicate that the various means, modules, logic, or circuitry within apparatus 600 are communicatively coupled and that communication of data and information occurs there between.

Apparatus 600 further includes a means or module 604 for determining within a mobile device at least a signal strength for at least one cell and whether the at least one cell meets at least one of signal strength and path loss criteria based on the determined signal strength. In particular, the module 604 is configured for performing the determination and may be implemented with a specific processor, such as an Application Specific Integrated Circuit (ASIC) or a field-programmable gate array (FPGA), or other suitable circuitry or dedicated logic. In an aspect, means or module 604 may be implemented with processing circuit 508 in conjunction with communications interface 502 in FIG. 5, as merely one example, or equivalents thereof.

Additionally, apparatus 600 includes a module or means 606 for determining whether the at least one cell supports packet switched service (PS) if the mobile device is configured for PS only. This module or means 606 may be implemented with a specific processor, such as an Application Specific Integrated Circuit (ASIC) or a field-programmable gate array (FPGA), or other suitable circuitry or dedicated logic. As an example, module or means 606 may be implemented with processing circuit 508 in conjunction with communications interface 502 in FIG. 5 as one example, or equivalents thereof.

Apparatus 600 further includes a module or means 608 for selecting to receive service from the cell when the at least one cell supports packet switched service. Module or means 608 may be implemented This module or means 606 may be implemented with a specific processor, such as an Application Specific Integrated Circuit (ASIC) or a field-programmable gate array (FPGA), or other suitable circuitry or dedicated logic. As an example, module or means 608 may be implemented with processing circuit 508 in conjunction with communications interface 502 in FIG. 5 as one example, or equivalents thereof.

Furthermore, apparatus 600 may include an optional module or means 610 for deleting cell entries in a neighbor list of a UE, such as neighbor list 512, such as in the case of cell reselection shown in FIG. 3, but could also be utilized in the case of initial cell selection of FIG. 2 as well. It is noted that portions or all of such processing by module 610 may be implemented with a specific processor, such as an Application Specific Integrated Circuit (ASIC) or a field-programmable gate array (FPGA), or other suitable circuitry or dedicated logic. As an example, module or means 610 may be implemented with processing circuit 508 in conjunction with storage medium 510 and the neighbor list database 512 in FIG. 5 as one example, or equivalents thereof.

In an aspect, apparatus 600 may be utilized in a Class C device or UE. In another aspect, a radio technology utilized by apparatus 600 is GPRS in a GERAN environment. In a further aspect, module means 604, 606, 608, and 610 could be implemented with the assistance of multiple processor(s) in a UE, such as UE 104 or 500, and may also include other equivalent devices or structures for carrying out the functions or methodologies disclosed herein.

In light of the foregoing, it will be evident that the presently disclosed methods and apparatus provide the ability for a particular type of device configured to receive only PS service (e.g., a Class C device) to avoid selection of a cell that does not support PS service. In this way an end user device can ensure having the PS service for which it is designed.

It is also noted that the various concepts presented throughout this disclosure may be implemented across a broad variety of telecommunication systems, network architectures, and communication standards. Certain aspects of the discussions are described herein in relation to Global System for Mobile Communications (GSM), and in relation to 3^{rd} Generation Partnership Project (3GPP) protocols and systems, and related terminology may be found in much of the foregoing description. However, those of ordinary skill in the art will recognize that one or more aspects of the present disclosure could be adapted to be employed and included in one or more other wireless communication protocols and systems.

It is noted that at least some implementations have been described as a process that is depicted as a flowchart, a flow diagram, a structure diagram, or a block diagram. Although a flowchart may describe the operations as a sequential process, at least some of the operations could be performed in parallel or concurrently. In addition, it is understood that the specific order or hierarchy of steps in the disclosed processes may be rearranged while remaining within the scope of the present disclosure. A process may correspond to a method, a function, a procedure, a subroutine, a subprogram, etc. When a process corresponds to a function, its termination may also correspond to a return of the function to the calling function or the main function. The accompanying method claims present elements of the various steps in a sample order, and are not meant to be limited to the specific order or hierarchy presented.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow. The techniques described herein may be used for various communication systems, including communication systems that are based on an orthogonal multiplexing scheme.

The terms “memory” or “storage medium” may encompass any electronic component capable of storing electronic information. In particular, these terms may connote various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

Also, the terms “instructions” and “code” may include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is used for proper operation of the method that is being described, the order and/or use of specific steps and/or actions may be modified without departing from the scope of the claims.

Finally, it is to be understood that the claims are not limited to the precise configuration and components illustrated above. Various modifications, changes and variations may be made in the arrangement, operation, and details of the systems, methods, and apparatus described herein without departing from the scope of the claims.

What is claimed is:

1. A method for wireless communication, comprising:
determining within a mobile device at least a signal strength for at least one cell and whether the at least one cell meets at least one of signal strength and path loss criteria based on the determined signal strength;
determining whether the at least one cell supports packet switched service (PS); and
selecting to receive service from the cell when the at least one cell supports packet service.

2. The method of claim 1, wherein the mobile device is configured as a Class C General Packet Radio Service (GPRS) device.

3. The method of claim 1, further comprising:
establishing within the mobile device a list of available cells based on the determining of the at least a signal strength for at least one cell; and
selecting a next cell in the list when the cell has been determined not to support packet switched service (PS).

4. The method of claim 1, further comprising:
establishing within the mobile device a list of available cells based on the determining of the at least a signal strength for at least one cell; and
deleting a cell from the list of available cells when determining the cell does not support PS.

5. The method of claim 1, wherein determining whether the at least one cell supports PS includes checking a system information message received from a network node.

6. The method of claim 5, wherein the system information message comprises GSM System information message SI3.

7. The method of claim 1, wherein the step of determining whether the at least one cell supports packet switched service (PS) further comprises determining whether the at least one cell supports packet switched service (PS) if the mobile device is configured for PS only.

8. The method of claim 1, further comprising determining whether the cell is barred for use by the mobile device.

9. The method of claim 1, further comprising determining whether a particular public land mobile network (PLMN) associate with the particular cell is forbidden.

10. A mobile device comprising:
a communications interface configured to communicate in at least one radio access network;
a storage medium; and
a processing circuit coupled to the communications interface and the storage medium and configured to:
determine within a mobile device at least a signal strength for at least one cell and whether the at least one cell meets at least one of signal strength and path loss criteria based on the determined signal strength;
determine whether the at least one cell supports PS; and
select to receive service from the cell when the at least one cell supports packet switched service.

11. The mobile device of claim 10, wherein the mobile device is configured as a Class C General Packet Radio Service (GPRS) device.

12. The mobile device of claim 10, wherein the processing circuit is further configured to:
establish within the mobile device a list of available cells based on the determining of the at least a signal strength for at least one cell; and
select a next cell in the list when the cell has been determined not to support packet switched service (PS).

13. The mobile device of claim 10, wherein the determine whether the at least one cell supports packet switched service (PS) further comprises determine whether the at least one cell supports packet switched service (PS) if the mobile device is configured for PS only.

14. The mobile device of claim 10, wherein the processing circuit is further configured to:
establish within the mobile device a list of available cells based on the determining of the at least a signal strength for at least one cell; and
delete a cell from the list of available cells when determining the cell does not support PS.

15. The mobile device of claim 10, wherein the processing circuit is further configured to determine whether the at least one cell supports PS by checking a system information message received from a network node.

16. The mobile device of claim 15, wherein the system information message comprises GSM System information message SI3.

17. An apparatus for wireless communication, comprising:
means for determining within a mobile device at least a signal strength for at least one cell and whether the at least one cell meets at least one of signal strength and path loss criteria based on the determined signal strength;
means for determining whether the at least one cell supports packet switched service (PS); and
means for selecting to receive service from the cell when the at least one cell supports packet switched service.

18. The apparatus of claim 17, wherein the mobile device is configured as a Class C General Packet Radio Service (GPRS) device.

19. The apparatus of claim 17, further comprising:
means for establishing within the mobile device a list of available cells based on the determining of the at least a signal strength for at least one cell; and
means for selecting a next cell in the list when the cell has been determined not to support packet switched service (PS).

20. The apparatus of claim 17, further comprising:
means for establishing within the mobile device a list of available cells based on the determining of the at least a signal strength for at least one cell; and
means for deleting a cell from the list of available cells when determining the cell does not support PS.

21. The apparatus of claim 17, wherein the means for determining whether the at least one cell supports PS includes means for checking a system information message received from a network node.

22. The apparatus of claim 17, wherein the means for determining whether the at least one cell supports packet switched service (PS) further comprises means for determining whether the at least one cell supports packet switched service (PS) if the mobile device is configured for PS only.

23. The apparatus of claim 17, wherein the system information message comprises GSM System information message SI3.

24. A computer program product for selecting a cell in a wireless communication system, comprising:
a computer-readable storage medium comprising:
code for causing a computer to determine within a mobile device at least a signal strength for at least one cell and whether the at least one cell meets at least one of signal strength and path loss criteria based on the determined signal strength;
code for causing a computer to determine whether the at least one cell supports packet switched service (PS); and
code for causing a computer to select to receive service from the cell when the at least one cell supports packet switched service.

25. The computer program product of claim 24, wherein the mobile device is configured as a Class C General Packet Radio Service (GPRS) device.

26. The computer program product of claim 24, the computer-readable storage medium further comprising:
code for causing a computer to establish within the mobile device a list of available cells based on the determining of the at least a signal strength for at least one cell; and
code for causing a computer to select a next cell in the list when the cell has been determined not to support packet switched service (PS).

27. The computer program product of claim 24, the computer-readable storage medium further comprising:
code for causing a computer to establish within the mobile device a list of available cells based on the determining of the at least a signal strength for at least one cell; and
code for causing a computer to delete a cell from the list of available cells when determining the cell does not support PS.

28. The computer program product of claim 24, wherein the code for causing a computer to determine whether the at least one cell supports PS further includes code for causing a computer to check a system information message received from a network node.

29. The computer program product of claim 28, wherein the system information message comprises GSM System information message SI3.

30. The computer program product of claim 24, wherein the code for causing a computer to determine whether the at least one cell supports packet switched service (PS) further comprises code for causing a computer to determine whether the at least one cell supports packet switched service (PS) if the mobile device is configured for PS only.
